(19) United States
(12) Patent Application Publication
(10) Pub. No.: US 2026/0320429 A1
(43) Pub. Date: Oct. 15, 2026

(54) PREDICTION DATA CALIBRATION FOR CONTENT DISTRIBUTION

(71) Applicant: Google LLC, Mountain View, CA (US)

(72) Inventors: Kumar Rishabh, San Jose, CA (US); Wei Huang, Bellevue, WA (US); Liang Wang, Bellevue, WA (US); Zhenyu Liu, San Jose, CA (US)

(21) Appl. No.: 18/859,134

(22) PCT Filed: Sep. 17, 2024
(86) PCT No.: PCT/US2024/047073

§ 371 Date: Oct. 22, 2024

Related U.S. Application Data
(60) Provisional application No. 63/615,877, filed on Dec. 29, 2023.

(51) Int. Cl. G06N 5/04

(52) U.S. Cl. CPC G06N 5/04

(57) ABSTRACT

Methods, systems, and apparatus, including computer programs encoded on a computer storage medium, for distributing digital components to client devices. The system receives a calibration request for calibrating a machine learning model, generates, according to the request, a calibration dataset. The system performs one or more calibration processes to generate one or more calibration thresholds using the calibration dataset, and applies the one or more calibration thresholds to the prediction scores generated by the machine learning model to generate calibrated prediction data including one or more predicted classifications. The system distributes the digital components to the client devices using calibrated prediction data.

### CROSS-REFERENCE TO RELATED APPLICATION

This application claims priority to U.S. Provisional Patent Application No. 63/615,877, filed on Dec. 29, 2023, the disclosure of which is hereby incorporated by reference in its entirety and for all purposes.

### TECHNICAL FIELD

This specification generally relates to machine learning, artificial intelligence, and data calibration.

### BACKGROUND

Many applications involve distributing digital content to client devices. The distribution of digital content is often conditioned on prediction data.

A machine learning model can be used for generating prediction data. A machine learning model is a computational model that learns patterns and relationships in data, and then uses that knowledge to make predictions or decisions on new data. The model parameters of a machine learning model can be learned based on training data.

### SUMMARY

This specification describes methods, computer systems, and apparatus, including computer programs encoded on computer storage media, for calibrating a machine learning model that has been trained to predict data for distributing digital components to client devices.

In one aspect, this specification describes a method for distributing digital components to client devices. The method can be implemented by a system including one or more computers. The system receives a calibration request for calibrating a machine learning model. The machine learning model has been trained on training data and is configured to process an input to generate prediction data for distributing digital components to client devices. The prediction data includes one or more prediction scores. The system generates, according to the request, a calibration dataset. The system performs one or more calibration processes to generate one or more calibration thresholds using the calibration dataset, and applies the one or more calibration thresholds to the prediction scores generated by the machine learning model to generate calibrated prediction data including one or more predicted classifications. The system distributes the digital components to the client devices using calibrated prediction data. Other implementations of this aspect include corresponding apparatus, systems, and computer programs, configured to perform the aspects of the methods, encoded on computer storage devices.

In some implementations, the machine learning model is configured to (i) process the input including data specifying one or more contextual signals included in a digital component request from a client device, and to (ii) generate the prediction data about the user of the client device based on the input.

In some implementations, the machine learning model is configured to (i) process an input including data characterizing a digital content item to (ii) generate the prediction data about an audience segment for the digital content item based on the input.

In some implementations, the one or more calibration thresholds are determined to optimize an objective for matching a distribution of the predicted classifications to a predefined classification distribution.

In some implementations, the one or more calibration thresholds are determined for the predicted classifications to satisfy one or more prediction quality criteria.

In some implementations, to determine the one or more calibration thresholds using the calibration dataset, the system optimizes a set of decision variables using the calibration dataset using joint optimization. In some implementations, to determine the one or more calibration thresholds using the calibration dataset, the system optimizes a set of decision variables using the calibration dataset using piece-wise optimization.

In some implementations, the calibration request includes calibration configuration data for calibrating the machine learning model. For example, in some cases, the calibration configuration data specifies the one or more calibration processes to generate the one or more calibration thresholds, and the one or more calibration processes are selected from a predefined set of calibration processes. In some cases, the calibration configuration data specifies a set of data sources to be used to generate the calibration dataset.

In some implementations, the calibration dataset is generated using data from a plurality of data sources. For example, in some cases, the data from the plurality of data sources includes log data and/or survey data. In some cases, the data from the plurality of data sources includes data that has been processed and assigned with aggregation keys. In some cases, the data from the plurality of data sources includes data generated by applying the trained machine learning model to input data. In some cases, to generate the calibration dataset, the system joins keyed data entries from two or more of the plurality of data sources. For example, to join the keyed data entries from the plurality of data sources, the system determines a primary join key, and joins the keyed data entries from at least two of the data sources using the primary join key. The primary join key can include an event ID identifying a user query of a data entry. The primary join key includes a digital component ID identifying a digital component of a data entry. In some cases, the primary join key has been encrypted. In some cases, to join the keyed data entries from the plurality of data sources, the system further determines a secondary join key, and joins the keyed data entries from at least two of the data sources using the secondary join key. For example, the secondary join key can include a user ID identifying a user of a data entry. In some cases, the secondary join key has been encrypted.

In some cases, the data from the plurality of data sources includes a set of data entries specifying digital components and a respective set of audience segments for each digital component. To generate the calibration dataset, for each data entry in the set of data entries, the system obtains semantic relevance scores for the audience segments in the data entry, the semantic relevance scores characterizing the relevance of the corresponding audience segments to the respective digital component of the data entry, and removes a subset of the audience segments that have semantic relevance scores below a predefined threshold from the data entry.

In some implementations, at least a portion of the data from the plurality of data sources is encoded using a data compression process. In some cases, the data compression process includes: reducing the precision of each of a set of floating-point values to a predetermined number of decimal places; encoding the reduced-precision decimal values into binary encoded decimal representations; grouping a plurality of the binary encoded decimal representations together and encoding them as a single value; and converting the binary encoded values back to floating-point numbers. In some cases, the set of floating-point values are values of a vector outputted by the machine learning model.

In some implementations, after performing the calibration processes and before applying the calibration thresholds to the prediction scores generated by the machine learning model, the system further performs validation of the calibration thresholds on a validation dataset. For example, to perform the validation of the calibration thresholds, the system obtains a set of validation rules; and checks whether calibration thresholds satisfy the validation rules using the validation dataset. In some cases, the set of validation rules are specified in calibration configuration data included in the calibration request.

In some implementations, the system repeatedly generates the calibration dataset and performs the calibration processes.

This specification also provides a system including one or more computers and one or more storage devices storing instructions that, when executed by the one or more computers, cause the one or more computers to perform the method described above.

This specification also provides one or more computer storage media storing instructions that when executed by one or more computers, cause the one or more computers to perform the method described above.

Particular embodiments of the subject matter described in this specification can be implemented so as to realize one or more of the following advantages. A content distribution system can leverage user data of a set of users, e.g., users that have accessed a particular electronic resource (e.g., website) or a digital component (e.g., a video/audio clip, image, or text) to guide the selection and distribution of content to other users, e.g., to distribute content that best fits the interests or needs of the users. In particular, machine learning models can be trained to output predictions about unknown users of electronic resources, which can then be used to select and/or customize content (e.g., digital components) for the users. For example, the machine learning techniques allow for the selection and distribution of content that is relevant to users based on a limited set of signals, such as a resource locator for the electronic resource with which the content is presented, a type of device at which the content will be presented, coarse location information (e.g., country or region) for the device, and/or other user characteristics, by leveraging rich data about a set of users for which such data is available.

By using the trained machine learning models to select relevant content for presentation at the user devices, the online experience for the users can be improved, and the effectiveness of the content presentation of the content providers can be enhanced.

Further, the efficiency of transmitting content to client devices is improved as content that is not relevant to a particular user need not be transmitted. In addition, third-party cookies are not required thereby avoiding the transmission and storage of third-party cookies, improving memory usage, and reducing the amount of bandwidth that would otherwise be consumed by transmitting the cookies. For example, the described techniques enable accurate predictions using information included in a single request such that the collection and identification of data using third-party cookies is not required. Thus, the described techniques can continue to provide accurate results in situations in which third-party cookies are not available, e.g., due to the deprecation or blocking of such cookies by browsers or other applications.

Machine learning model calibration can greatly increase the accuracy and reliability of the models in real-world applications. Calibration in machine learning involves the transformation of raw output scores or probabilities generated by the model into calibrated data, such as a classification output, that can be used for various purposes including distributing digital components. In one approach, calibration can be performed by calibrating the loss function using quantile regression. In this process, the loss function is adjusted based on the differences between the predicted quantiles and the observed quantiles in the training data, and the model is re-trained using the modified loss function to re-train the model. The model is then validated and fine-tuned using a separate validation dataset. This process has several disadvantages. The computational complexity is high for quantile regression, especially for large datasets, leading to increased model complexity and an increased requirement of computational resources. The method is sensitive to data outliers, and the assumption of linearity can be problematic for certain models. The selection of quantiles for calibration is subjective, and not all machine learning models readily support quantile regression loss functions.

This specification provides techniques for calibrating the output generated by a machine learning model that has been trained to generate prediction data, e.g., prediction scores for various applications. For example, the machine learning model can be trained to predict whether a received file contains malicious code, and the calibrated prediction data can be used for more accurately detecting malicious code and thus preventing network security risks. In another example, the machine learning model can be trained to predict a future trajectory for an autonomous vehicle, and the calibration process can be used to provide a safety guarantee for the calibrated prediction data. In another example, the machine learning model can be trained to predict data about a digital component or a user requesting a digital component, and the calibration process can be used to improve the quality of the prediction data, and thus enable a system to more effectively select and distribute digital components that are relevant to the users. In some implementations, the calibration can be tailored to ensure that the calibrated predictions align with a particular distribution, e.g., a distribution that better represents a real-world data distribution. In some implementations, the calibration can be tailored to satisfy quality criteria such as precision, recall, or lift. The provided techniques, therefore, improve the accuracy and reliability of model outputs, aligning them with desired distributions and quality benchmarks for digital component distribution.

Additionally, training a complex machine learning model can be a resource-intensive process, requiring significant computational resources and time to update a large number of model parameters using training examples. When the data distribution undergoes changes over time, known as data drift, traditional approaches often require retraining the entire model (e.g., updating all of the model parameters) to adapt to the new data, further increasing the computational burden. This specification describes calibration techniques that are more efficient. Instead of retraining the entire model, the described techniques allow for continuously calibrating the model output based on newly available data. This means that the model's output can be adjusted to reflect the changes in the data distribution without updating the large number of model parameters. The provided techniques can help maintain the model's performance without requiring retraining even when the data distribution drifts over time, thus saving time and computational resources for model training especially when compared to techniques described above that include re-training using a modified loss function.

Furthermore, in some implementations of the described techniques, the calibration system implements a piecewise optimization process to optimize the calibration thresholds for multiple calibration objectives. Piecewise optimization breaks down the optimization problem into smaller, independent subproblems for each optimization objective. This allows for easier analysis and optimization of each subproblem. As a result, the calibration system requires less computational power and less time to solve compared to performing joint optimization, which needs to handle the multi-objective optimization problem all at once.

Furthermore, the techniques described herein provide a particular use of artificial intelligence (AI) to solve the problem of calibrating machine learning models for improved prediction accuracy by adapting model outputs to match real-world distributions and quality benchmarks. For example, in content distribution, it is important to ensure that the machine learning models generate reliable and accurate predictions relevant to content selection and recommendation. The described technique leverages AI technology, specifically in some implementations machine learning model calibration techniques, to adjust the raw output scores or probabilities from the model into calibrated data that better reflect the desired outcomes. This allows for more effective content distribution, ensuring that the content delivered to users is both relevant and meets specific quality standards. By continuously calibrating the model output based on new data, rather than relying solely on initial training data, the described techniques represent an advancement in maintaining model performance and adapting to evolving data distributions, e.g., in real-time which enables accurate model outputs that reflect current trends. Additionally, by performing a piecewise optimization process for calibrating multiple objectives, some implementations of the described techniques solve the problems arising from the complexity and computational demands of joint optimization, leading to more efficient and scalable calibration solutions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example environment in which a digital component distribution system distributes digital components to client devices.

FIG. 2 illustrates the data flow between components of the example environment of FIG. 1.

FIG. 3 is a flow diagram of an example process for distributing digital components to client devices.

FIG. 4 is a block diagram of an example computer system.

Like reference numbers and designations in the various drawings indicate like elements.

### DETAILED DESCRIPTION

In general, this specification describes systems and techniques for calibrating machine learning models and providing digital content, e.g., digital components, to client devices using the calibrated models. A trained machine learning model is used to generate prediction data, e.g., prediction scores, for distributing digital components. The prediction data can include, for example, predicted information about a user of a client device based on one or more contextual signals included in a digital component request received from the client device. In another example, prediction data can include predicted data about an audience segment for a digital component, for a video, for a group of videos, or for other content, based on data characterizing a digital component, or other content. One or more calibration processes are performed to generate one or more calibration thresholds using a calibration dataset, and the calibration thresholds are applied to the prediction scores to generate calibrated prediction data including one or more predicted classifications. A digital component distribution system can use the calibrated prediction data to adjust distribution parameters for distributing digital components to client devices in response to digital component requests.

Further to the descriptions throughout this document, a user may be provided with controls (e.g., user interface elements with which a user can interact) allowing the user to make an election as to both if and when systems, programs, or features described herein may enable the collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no apparently personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

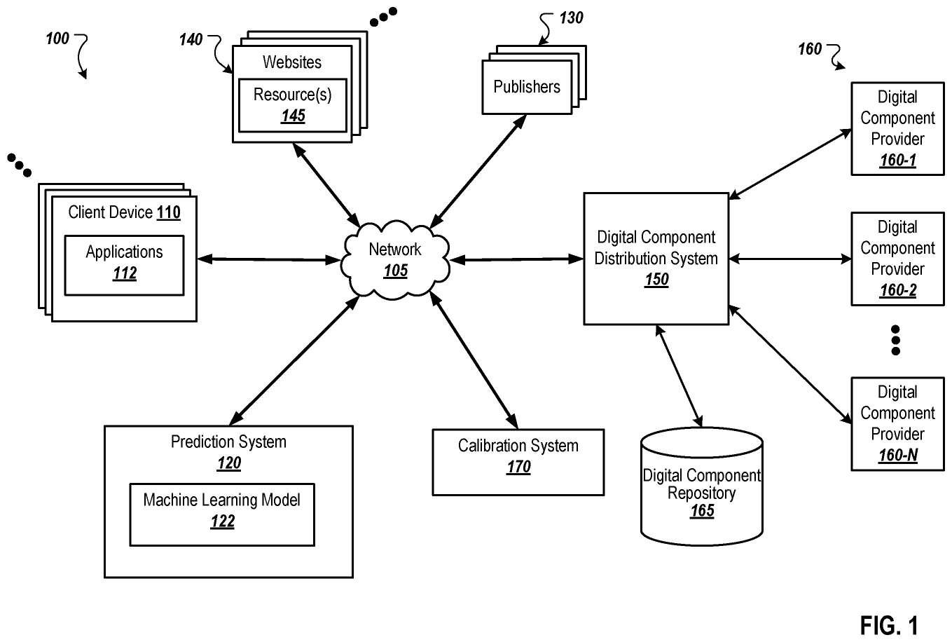

FIG. 1 is a block diagram of an example environment 100 in which a digital component distribution system 150 distributes digital components to client devices 110. The environment 100 includes a data communication network 105, e.g., a local area network (LAN), a wide area network (WAN), the Internet, a mobile network, or a combination thereof. The data communication network 105 connects the client devices 110, a prediction system 120, and a calibration system 170, to the digital component distribution system 150. The network 105 can also connect the digital component distribution system 150 to digital component providers, e.g., 160-1, 160-2, and 160-3.

A client device 110 is an electronic device capable of requesting and receiving online resources over the network 105. Example client devices 110 include personal computers, gaming devices, mobile communication devices, digital assistant devices, augmented reality devices, virtual reality devices, and other devices that can send and receive data over the network 105. A client device can also include a digital media device, e.g., a streaming device that plugs into a television or other display to stream videos to the television.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

The client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources, e.g., web pages, application pages, or other application content, to a user of the client device 110. An electronic resource is also referred to herein as a resource for brevity. In this specification, resources can include HTML pages, word processing documents, and portable document format (PDF) documents, images, video, native applications, application pages of native applications, and feed sources, to name only a few. The resources can include content, such as words, phrases, images and sounds, that may include embedded information (such as meta-information in hyperlinks) and/or embedded instructions (such as scripts). A resource can be identified by a resource address, e.g., a Universal Resource Locator (URL) or Uniform Resource Identifier (URI) that is associated with the resource.

A website 140 is one or more electronic resources associated with a domain name and hosted by one or more servers. An example website is a collection of web pages formatted in HTML that can contain text, images, multimedia content, and programming elements, such as scripts. Each website 140 is maintained by a publisher 130, which is an entity that controls, manages and/or owns the website 140.

The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

As used throughout this specification, the “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement the content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource that includes a digital component slot, the application 112 can generate a digital component request that requests a digital component for display in the digital component slot. In some implementations, the digital component slot and/or the resource can include code (e.g., scripts) that cause the application 112 to request a digital component from the digital component distribution system 150.

A digital component request can include contextual data. The contextual data can be related to, e.g., describe, the environment in which a selected digital component will be presented. The contextual data can include, for example, coarse location information indicating a general location of the client device 110 that sent the digital component request, a resource, e.g., website or native application, with which the selected digital component will be presented, e.g., by including a resource locator such as a URI or URL for the resource, a spoken language setting of the application 112 or client device 110, the number of digital component slots in which digital components will be presented with the resource, the types of digital component slots, and/or other appropriate contextual information. A digital component request can include other data, e.g., in addition to or in place of the contextual data.

The prediction system 120 uses a machine learning model 122 to generate prediction data, e.g., prediction scores, for distributing digital components. The machine learning model 122 has been trained, e.g., by a model training system, to generate the prediction data for distributing digital components to client devices. The prediction data can include predicted information about a user of a client device and/or predicted information about digital contents, e.g., the content of a video or group of videos, e.g., a video channel. The machine learning model can include any appropriate types of predictive machine learning model, e.g., a neural network or a decision trees model. The model can be trained using supervised learning based on a set of training examples with each training example including a respective training input and a corresponding output label.

In some implementations, the prediction data can include predicted information about a user of a client device based on one or more contextual signals included in a digital component request from the client device. For example, the machine learning model 122 can be trained to process a model input including the contextual signals to output a likelihood score for each label of a set of labels with each label corresponding to a topic of user interest or a user attribute. Examples of user attributes can include demographic information or other characteristics such as geographic location, spoken language, and device type of the device used by the user. The machine learning model 122 can be trained to output higher likelihood scores when it is more likely that the user has interest in the topic or has the attribute and lower likelihood scores if it is less likely that the user has interest in the topic or does not have the attribute. A training example for training the machine learning model 122 can include a training input specifying contextual signals in a respective digital component request and a corresponding training label that specifies the attributes of the user sending the respective digital component request.

In some implementations, the prediction data output by the machine learning model 122 can include predicted data about a digital content item, such as an audience segment for a digital component, for a video, for a group of videos, or for other content, based on data characterizing the content item. The data characterizing the content can include data such as title, description, author information, tags, keywords, format, length, style, video or audio transcript, and/or user viewing history. In general, a user segment can include a group of users that have been determined to be interested in a particular topic, a group of topics, or that have some other common attribute or group of attributes. Each user segment can have a corresponding topic and the users assigned to a user segment can be users that are determined to be interested in the topic. Example topics can include topics of interest, e.g., cats, books, travel, etc., or brands that represent long term interests of users, such as outdoors enthusiast, sports fan, gardener, etc. The machine learning model 122 can be trained to process an input including the data characterizing the content to output a likelihood score for each label of a set of labels that corresponds to a respective topic of user interest or a respective user attribute. The machine learning model 122 can be trained to output a higher likelihood score for a topic or user attribute when it is more likely that the digital component is of interest to users interested in the corresponding topic or users having the corresponding attribute.

As described in more detail below, the calibration system 170 performs one or more calibration processes to generate one or more calibration thresholds using a calibration dataset, and applies the calibration thresholds to the prediction scores generated by the machine learning model 122 to generate calibrated prediction data including one or more predicted classifications. For example, the machine learning model 122 can be trained to predict a likelihood score that indicates a likelihood that the user is interested in a particular topic. In this example, the calibration system 170 can generate a threshold score, and classify whether a user is interested in the particular topic by comparing the likelihood score predicted for the user to the threshold score. For example, if the likelihood score is equal to or greater than the threshold score, the calibration system 170 can classify the user as being interested in the particular topic. On the other hand, if the likelihood score is below the threshold score, the calibration system 170 can classify the user as not being interested in the particular topic.

In another example, the machine learning model 122 can be trained to predict a likelihood score of a digital component for being of interest to a particular user segment. In this example, the calibration system 170 can generate a threshold score for the likelihood score. The digital component can be classified as being of interest to the users in the particular user segment if the likelihood score is equal to or greater than the threshold score. Similarly, the digital component can be classified as not being of interest to the users in the particular user segment if the likelihood score is below the threshold score.

In yet another example, can be trained to predict a likelihood that a user segment is interested in a video or video group. In this example, the calibration system 170 can generate a threshold score for the likelihood score. If the likelihood score for a user segment is equal to or greater than the threshold, the user segment can be classified as being interested in the video or video group. Similarly, if the likelihood score for a user segment is less than the threshold, the user segment can be classified as not being interested in the video or video group.

The digital component distribution system 150 can identify a set of digital components that are eligible to be presented to the client device 110 from among a corpus of digital components. For example, the digital component distribution system 150 can select one or more digital components from digital components stored in a digital component repository 165 and/or a set of digital components received from digital component providers 160.

The digital component repository 165 can store digital components received from the digital component providers and additional data (e.g., metadata) for each digital component in a database. The metadata for a digital component can include, for example, distribution criteria that define the situations in which the digital component is eligible to be provided to a client device 110 in response to a digital component request received from the client device 110 and/or a selection parameter that indicates an amount that will be provided to the publisher if the digital component is displayed with a resource of the publisher and/or interacted with by a user when presented. The distribution criteria and the selection parameter can be characterized by one or more distribution parameters.

For example, the distribution parameters for a particular digital component can include distribution keywords that must be matched, e.g., by terms specified in a digital component request, in order for the digital component to be eligible for presentation. The keywords can include keywords of search queries and/or of resources for which a digital component is being requested. For example, the distribution parameters for a digital component can include a keyword and the digital component may only be eligible for presentation in response to digital component requests that include the keyword as a search query or a keyword of a resource.

In another example, the distribution criteria for a digital component can include location information indicating which geographic locations that digital component is eligible to be presented, user group membership data identifying user groups to which the digital component is eligible to be presented, resource data identifying resources with which the electronic resource is eligible to be presented, and/or other appropriate distribution criteria. The distribution criteria can also include negative criteria, e.g., criteria indicating situations in which the digital component is not eligible (e.g., with particular resources or in particular locations). The distribution parameters can also specify a selection parameter and/or resource limit for distributing the digital component.

The digital component distribution system 150 can be configured to select the digital components for presentation at client devices 110 based on the calibrated prediction data generated by the calibration system 170. For example, if the distribution parameters of a digital component specify that the digital component is eligible for presentation to users that are interested in a particular topic, the digital component distribution system 150 can use the calibrated prediction data to determine whether the user of a particular client device 110 is classified as being interested in the particular topic. The digital component distribution system 150 can distribute the digital component to the particular client device 110 (or increase the selection parameter) if the calibrated prediction data indicates that the user of the client device 110 is interested in the particular topic. In another example, the digital component distribution system 150 can use the calibrated prediction data to determine whether a video or a video channel is classified as being relevant to a particular user segment. When a user views the video or the video channel, the digital component distribution system 150 can select digital components that are eligible for that particular user segment to be distributed to the client device of the user if the video or video channel is classified as being relevant to the particular user segment.

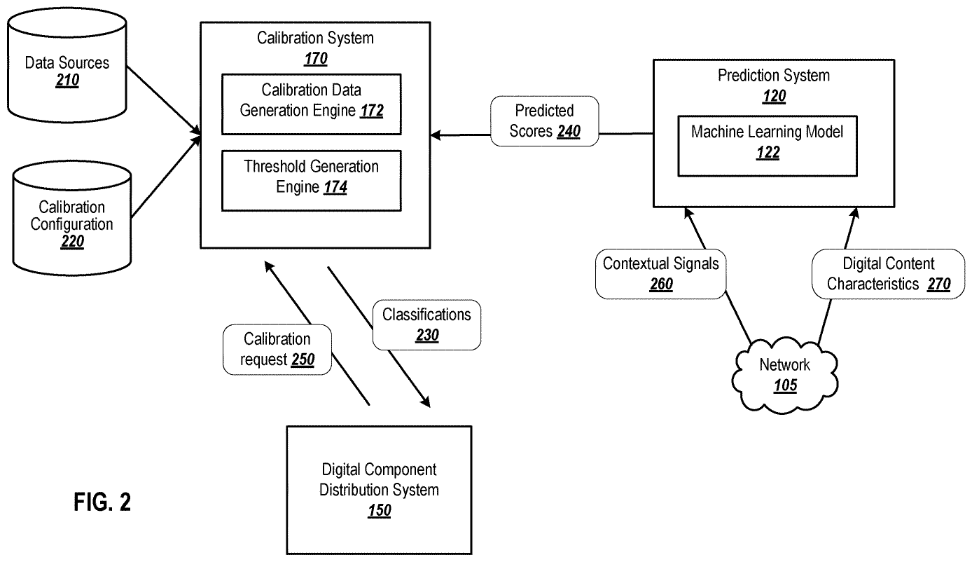

FIG. 2 illustrates data flow between certain components of the example environment 100 of FIG. 1. As shown in FIG. 2, the calibration system 170 receives a calibration request 250 from the digital component distribution system 150 for calibrating the prediction output of the machine learning model 122. In some implementations, the digital component distribution system 150 can send the calibration request 250 to calibration system 170, so that the calibration system 170 will update the calibration based on updated data on an ongoing basis, e.g., periodically or when triggered by an event or a user command. The calibration system 170 includes a calibration data generation engine 172 that generates, according to the request 250, a calibration dataset. The calibration system 170 further includes a threshold generation engine 174 that performs one or more calibration processes to generate one or more calibration thresholds using the calibration dataset.

The prediction system 120 uses the machine learning model 122 to process an input to generate a predicted score 240. For example, the prediction system 120 can process an input including contextual signals 260 in a digital component request to predict a likelihood score for a user being interested in a topic or having a particular user attribute. In another example, the prediction system 120 can process an input including characteristics 260 of a digital content item, e.g., a video or a video channel, to predict a likelihood score for the digital content item being relevant to a particular user segment.

The calibration system 170 receives the prediction scores 240 from the prediction system 120 and applies the calibration thresholds to the prediction scores to generate calibrated prediction data that include one or more predicted classifications 230. The digital component distribution system 150 uses the predicted classifications 230 to distribute digital components to the client devices.

The calibration data generation engine 172 can generate the calibration dataset using various data sources 210. In general, the calibration dataset can include data entries that link prediction inputs to prediction labels. For example, the calibration dataset can include data linking contextual signals included in digital component requests with interests or attributes of the users of the client devices that send the corresponding digital component requests. In another example, the calibration dataset can include data linking data characterizing digital content items (such as videos or video channels) with audience segments of the corresponding digital content items. In general, the data selected for the calibration dataset are different from the training data used for training the machine learning model 122.

In some implementations, the calibration data generation engine 172 can generate the calibration dataset using data from multiple data sources 210 such as government agencies, regulatory organizations, the public domain, and commercial data sources. The data from the data from multiple data sources 210 can include, e.g., log data and survey data. For example, survey data can include survey results of a cohort of users on user attributes such as demographic information or other characteristics such as geographic location, spoken language, and device type. Population priors, e.g., the distributions of different classes in the cohort of users, can be derived from the survey data of the cohort of users. In some implementations, the data from the data from multiple data sources 210 can include data that has been processed and assigned with aggregation keys. In some implementations, the data from the data from multiple data sources 210 can include data generated by applying the trained machine learning model 122 to input data. In another example, the log data can include historical log entries for past distributions of digital components. The log data can include information such as locale, time, geographic location, context of the distribution (e.g., the slots where the digital component was shown, how long the digital component was shown, number of times the digital component was viewed), information about the user, context of the device (e.g., device type and operating system), and audience profile (e.g., an affinity group of the user), and so on.

In some implementations, the calibration data generation engine 172 can generate the calibration dataset by joining keyed data entries from two or more of the data sources 210. For example, in order to join data from at least two data sources, the calibration data generation engine 172 can determine a primary join key, and join the keyed data entries from the two or more data sources using the primary join key. As an example, if two data sources each include data having a keyed column of “event ID” identifying the user queries of the corresponding data entries, the calibration data generation engine 172 can use a primary join key of “event ID” for joining the data from the two data sources, so that event IDs in the joined data are consistent with the event IDs in the data entries from the two data sources. The primary join key is not limited to the “event ID”, and can include other keys such as a digital component ID identifying a digital component of a data entry. In some implementations, the primary join key can be an encrypted key, such as an encrypted event ID or an encrypted digital component ID.

In some implementations, after joining data from data sources using the primary join key, the calibration data generation engine 172 can further determine a secondary join key, and join the keyed data entries from at least two of the data sources using the secondary join key. For example, if two data sources each include data having a keyed column of “user ID” identifying the users of the corresponding data entries, the calibration data generation engine 172 can use a second join key of “user ID” for joining the data from the two data sources, so that user IDs in the joined data are consistent with the event IDs in the data entries from the two data sources. The secondary join key can also be an encrypted key.

In some implementations, the data from the multiple data sources 210 include a set of data entries specifying digital components and a respective set of audience segments for each digital component. The calibration data generation engine 172 can perform semantic filtering to remove data that is less relevant. In particular, the calibration data generation engine 172 can obtain semantic relevance scores for the audience segments in the data entry. The semantic relevance scores characterize the relevance of the corresponding audience segments to the respective digital component of the data entry. The semantic relevance scores can be obtained using semantic analysis techniques, e.g., by using a semantic similarity map that maps the semantical relevancies between taxonomy segments and characteristics of the digital components. The calibration data generation engine 172 can remove a subset of the audience segments that have semantic relevance scores below a predefined threshold from the data entry.

The threshold generation engine 174 performs the calibration processes to generate one or more calibration thresholds using the calibration dataset. In some implementations, the calibration thresholds can be determined to optimize an objective for matching a distribution of the predicted classifications to a predefined (e.g., a priori) classification distribution or a classification determined based on the calibration data. For example, when a priori classification distribution of an audience specifies that 30% of the users in the audience are interested in a particular topic, the calibration thresholds can be adjusted such that when the calibration thresholds are applied to the prediction scores 240, the calibrated prediction data will classify 30% of the users in the audience as being interested in the particular topic based on the calibration data.

In some other implementations, the thresholds can be determined for the predicted classifications to satisfy one or more prediction quality criteria. For example, if a prediction quality criterion specifies that “precision*lift>0.5” should be satisfied for the predictions, the calibration thresholds can be adjusted such that when the calibration thresholds are applied to the prediction scores 240, the calibrated prediction data will satisfy the quality criterion based on the calibration data. In general, the “precision” measures the proportion of positive predictions that are actually correct, and the “lift” measures the improvement in an outcome achieved by using a model prediction compared to a baseline, e.g., by choosing randomly.

In general, the calibration processes can include performing an optimization search for the calibration thresholds using the calibration dataset as the benchmark data to achieve the optimization objectives for the calibration dataset. Any appropriate optimization search techniques can be adopted for performing the optimization. In some implementations, the threshold generation engine 174 determines the calibration thresholds using joint optimization. Joint optimization refers to the process of optimizing for all of the optimization objectives simultaneously. For example, threshold generation engine 174 can jointly optimize for all the calibration objectives required to find the calibration thresholds, and carry out the optimization search collectively. Joint optimization can potentially lead to a globally optimized solution.

In some other implementations, the threshold generation engine 174 determines the calibration thresholds using piece-wise optimization. Piecewise optimization involves defining a complex optimization problem into smaller, more manageable sub-problems that are solved sequentially, for example, by performing the optimization search individually (e.g., sequentially) for each of the calibration objections. Piecewise optimization is usually easier to solve and requires fewer computation resources. In an illustrating example, the goal of the calibration is to generate a threshold score that satisfies two objectives including (1) achieving a classification precision greater than 0.5 and (2) matching a distribution of the predicted classifications to a classification distribution from survey data. To apply the piece-wise optimization, the threshold generation engine 174 first identify the minimal threshold which passes the precision criterion by performing a binary search on a monotonically increasing function. Next, among the values above the minimal threshold, the threshold generation engine 174 identify a threshold which allows the classification to match the survey distribution by performing a second binary search on a second monotonic function.

In some implementations, in order to save storage space, the calibration system 170 or another system can encode at least a portion of the data from the data sources 210 using a data compression process. The data compression process involves several steps. Firstly, it reduces the precision of each floating-point value in a set to a predefined number of decimal places. Subsequently, the reduced-precision decimal values are encoded into binary encoded decimal representations. To further optimize storage, a multitude of these binary encoded decimal representations can be grouped together and encoded as a single value. The compressed data can then be converted back to floating-point numbers. In some implementations, the set of floating-point values are values of a vector outputted by the machine learning model.

In some implementations, the calibration system 170 can perform a validation process of the calibration thresholds on a validation dataset after performing the calibration processes. To perform the validation of the calibration thresholds, the calibration system 170 can obtain a set of validation rules, and check whether calibration thresholds satisfy the validation rules using the validation dataset. The validation rules can include, for example, the minimum and maximum values of the thresholds, a maximum deviation from a baseline threshold value, and a source of the validation dataset. In some implementations, the validation rules can be specified in calibration configuration data included in the calibration request.

In some implementations, the calibration system 170 can repeatedly, e.g., periodically, generate the calibration dataset based on updated data from the data sources and perform the calibration processes on an ongoing basis, e.g., periodically or when triggered by an event or a user command. For example, the calibration process can be repeatedly performed according to configuration data which specifies a frequency or schedule for performing the calibration, e.g., every day, every week, every month, or every 6 months. In another example, the calibration system 170 or another system can repeatedly monitor the change in the class distribution in a user cohort computed from newly available survey data, and determine to perform the calibration system again when the change in the class distribution from the new data exceeds a threshold. In another example, the calibration system 170 can perform the calibration process again when receiving a command that specifies a different set of calibration objectives, e.g., a different set of prediction quality criteria. By repeatedly calibrating the model output based on updated available data, the calibration system 170 can help maintain the quality of the calibrated classifications 230 even when the data distribution drifts over time or if the requirement for the prediction quality changes.

In some implementations, the calibration system 170 can perform the calibration using a streamlined process defined in calibration configuration data. For example, different types of machine learning models can require different calibration objectives and different data sources, and the calibration request 250 can include calibration configuration data for calibrating the output of a specific machine learning model. The calibration configuration data can specify one or more calibration objectives. The calibration configuration data can specify a set of data sources to be used to generate the calibration dataset, and provide the details, e.g., data description and dimensions, of the data in the data sources. In some cases, the calibration configuration data includes a threshold of the class distribution change for triggering the calibration system 170 to repeat the calibration process.

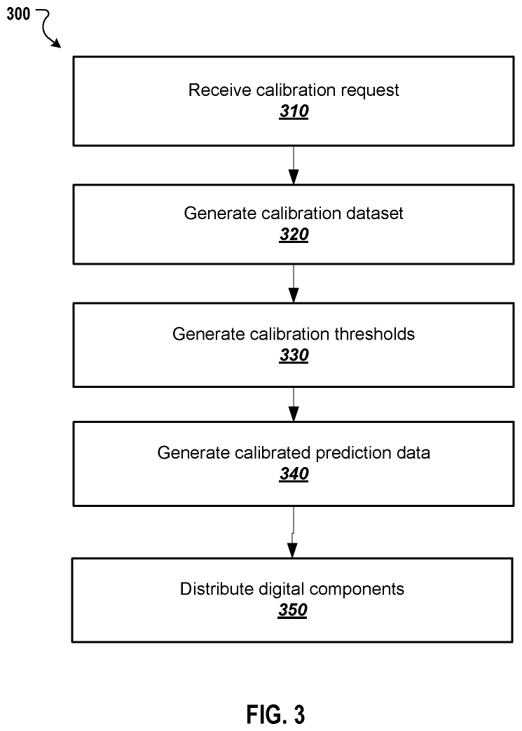

FIG. 3 is a flow diagram of an example process 300 for distributing digital components to client devices. Operations of the process 300 can be performed by a system of one or more computers located in one or more locations, such as a server, e.g., the calibration system 170 and the digital component distribution system 150 described with reference to FIGS. 1 and 2. Operations of the process 300 can also be implemented as instructions stored on one or more computer-readable media, which may be non-transitory, and execution of the instructions by one or more data processing apparatus can cause the one or more data processing apparatus to perform the operations of the process 300. For convenience and without loss of generality, the process 300 will be described as being performed by a data processing apparatus, and in particular, a computer system.

At 310, the computer system receives a calibration request for calibrating output of a machine learning model. The machine learning model has been trained on training data and is configured to process an input to generate prediction data for distributing digital components to client devices, the prediction data comprising one or more prediction scores. In some implementations, the process 300 can be applied to various machine learning models, and the calibration request includes configuration data that defines information such as the calibration objectives and calibration data sources for calibrating the particular machine learning model.

In one example, the machine learning model is configured to (i) process an input comprising data specifying one or more contextual signals included in a digital component request from a client device and to (ii) generate the prediction data about the user of the client device based on the input. The configuration data can specify the configuration objectives including (i) an objective for matching a distribution of the predicted classifications to a predefined classification distribution and (ii) one or more prediction quality criteria.

In another example, the machine learning model is configured to (i) process an input comprising data characterizing a digital content item (e.g., a video or a video channel) to (ii) generate the prediction data about an audience segment for the digital content item based on the input. The configuration data can specify the configuration objectives including one or more prediction quality criteria.

At 320, the computer system generates, according to the request, a calibration dataset. In particular, the computer system can generate the calibrating dataset using data from multiple data sources such as government agencies, regulatory organizations, the public domain, and commercial data sources. The data from the data from multiple data sources can include, e.g., log data and survey data. The system can generate the calibration dataset by joining keyed data entries from two or more of the data sources.

At 330, the computer system performs one or more calibration processes to generate one or more calibration thresholds using the calibration dataset. In particular, the system can perform one or more optimization searches for determining the calibration thresholds using the calibration dataset as the benchmark data to achieve the optimization objectives. In some implementations, the system can determine the calibration thresholds using joint optimization. In some other implementations, the system can determine the calibration thresholds using piece-wise optimization, which involves defining the optimization problem into a set of sub-problems that are solved sequentially.

At 340, the computer system applies the one or more calibration thresholds to the prediction scores generated by the machine learning model to generate calibrated prediction data including one or more predicted classifications. In particular, the system compares a prediction score outputted by the machine learning model to the calibration threshold, and determines a classification based on the comparison result. For example, the machine learning model has been trained to predict a likelihood score for the user having interests in a particular topic. The system can classify whether a user is interested in the particular topic by comparing the likelihood score predicted for the user and the threshold score (generated at 330). That is, if the likelihood score is equal to or greater than the threshold score, the system classifies the user as being interested in the particular topic. On the other hand, if the likelihood score is below the threshold score, the system classifies the user as not being interested in the particular topic. In another example, the machine learning model has been trained to predict a likelihood score of a digital item for being of interest to a particular user segment. The system can classify the digital item as being of interest to the users in the particular user segment if the likelihood score is equal to or greater than the threshold score (determined at 330), and classify the digital component as not being of interest to the users in the particular user segment if the likelihood score is below the threshold score.

At 350, the computer system distributes the digital components to the client devices using calibrated prediction data. The system can select the digital components for presentation at client devices based on the calibrated prediction data. For example, if the distribution parameters of a digital component specify that the digital component is eligible for presentation to users that are interested in a particular topic, and the user of a particular client device is classified as being interested in the particular topic (at 340), the system can distribute the digital component to the particular client device (or increase the selection parameter and/or resource limit for distributing the digital component to the particular client device). In another example, if the system has classified (at 340) that a video or a video channel as being relevant to a particular user segment, when a user views the video or the video channel, the system can select digital components that are eligible for that particular user segment to be distributed to the client device.

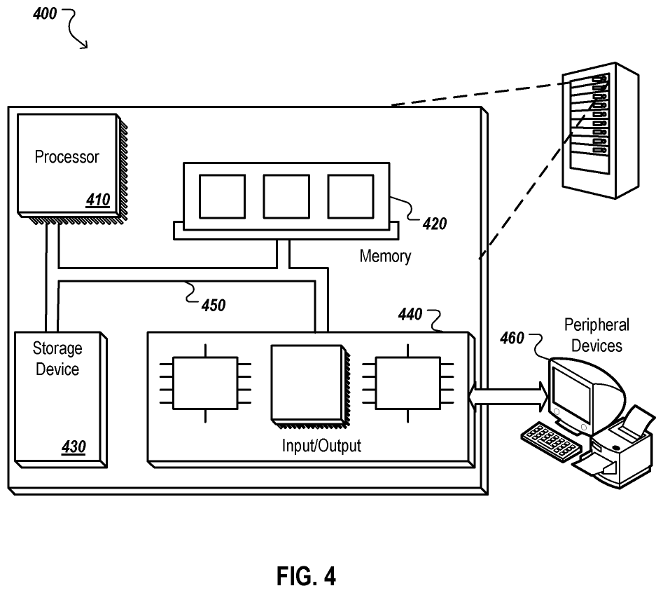

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400.

In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving a calibration request for calibrating a machine learning model, wherein the machine learning model has been trained on training data and is configured to process an input to generate prediction data for distributing digital components to client devices, the prediction data comprising one or more prediction scores;
generating, according to the request, a calibration dataset;
performing one or more calibration processes to generate one or more calibration thresholds using the calibration dataset;
applying the one or more calibration thresholds to the prediction scores generated by the machine learning model to generate calibrated prediction data comprising one or more predicted classifications; and
distributing the digital components to the client devices using calibrated prediction data.

2. The method of claim 1, wherein the machine learning model is configured to (i) process the input comprising data specifying one or more contextual signals included in a digital component request from a client device and to (ii) generate the prediction data about the user of the client device based on the input.

3. The method of claim 1, wherein the machine learning model is configured to (i) process an input comprising data characterizing a digital content item to (ii) generate the prediction data about an audience segment for the digital content item based on the input.

4. The method of claim 1, wherein the one or more calibration thresholds are determined to optimize an objective for matching a distribution of the predicted classifications to a predefined classification distribution.

5. The method of claim 1, wherein the one or more calibration thresholds are determined for the predicted classifications to satisfy one or more prediction quality criteria.

6. The method of claim 1, wherein determining the one or more calibration thresholds using the calibration dataset comprises:
optimizing a set of decision variables using the calibration dataset using joint optimization.

7. The method of claim 1, wherein determining the one or more calibration thresholds using the calibration dataset comprises:
optimizing a set of decision variables using the calibration dataset using piece-wise optimization.

8. The method of claim 1, wherein the calibration request comprises calibration configuration data for calibrating the machine learning model.

9. The method of claim 8, wherein the calibration configuration data specifies the one or more calibration processes to generate the one or more calibration thresholds, wherein the one or more calibration processes are selected from a predefined set of calibration processes.

10. The method of claim 8, wherein the calibration configuration data specifies a set of data sources to be used to generate the calibration dataset.

11. The method of claim 1, wherein the calibration dataset is generated using data from a plurality of data sources.

12. The method of claim 11, wherein the data from the plurality of data sources comprises log data.

13. (canceled)

14. The method of claim 11, wherein the data from the plurality of data sources comprises data that has been processed and assigned with aggregation keys.

15. (canceled)

16. The method of claim 11, wherein generating the calibration dataset comprise:
joining keyed data entries from two or more of the plurality of data sources.

17. The method of claim 16, wherein joining the keyed data entries from the plurality of data sources comprises:
determining a primary join key; and
joining the keyed data entries from at least two of the data sources using the primary join key.

18. (canceled)

19. (canceled)

20. The method of claim 17, wherein the primary join key has been encrypted.

21. The method of claim 17, wherein joining the keyed data entries from the plurality of data sources further comprises:
determining a secondary join key; and
joining the keyed data entries from at least two of the data sources using the secondary join key.

22. The method of claim 21, wherein the secondary join key comprises a user ID identifying a user of a data entry.

23. The method of claim 21, wherein the secondary join key has been encrypted.

24. The method of claim 11, wherein the data from the plurality of data sources comprises a set of data entries specifying digital components and a respective set of audience segments for each digital component, and generating the calibration dataset comprises, for each data entry in the set of data entries:
obtaining semantic relevance scores for the audience segments in the data entry, the semantic relevance scores characterizing relevance of the corresponding audience segments to the respective digital component of the data entry; and
removing a subset of the audience segments that have semantic relevance scores below a predefined threshold from the data entry.

25. The method of claim 11, wherein at least a portion of the data from the plurality of data sources is encoded using a data compression process.

26. The method of claim 25, wherein the data compression process comprises:
reducing precision of each of a set of floating-point values to a predetermined number of decimal places;
encoding the reduced-precision decimal values into binary encoded decimal representations;
grouping a plurality of the binary encoded decimal representations together and encoding them as a single value; and
converting the binary encoded values back to floating-point numbers.

27. The method of claim 26, wherein the set of floating-point values are values of a vector outputted by the machine learning model.

28. The method of claim 1, further comprising:
after performing the calibration processes and before applying the calibration thresholds to the prediction scores generated by the machine learning model, performing validation of the calibration thresholds on a validation dataset.

29. The method of claim 28, wherein performing the validation of the calibration thresholds comprises:
obtaining a set of validation rules; and
checking whether calibration thresholds satisfy the validation rules using the validation dataset.

30. The method of claim 29, wherein the set of validation rules are specified in calibration configuration data included in the calibration request.

31. The method of claim 1, wherein generating the calibration dataset and performing the calibration processes are repeatedly performed.

32. (canceled)

33. (canceled)
